(19) United States
(12) Patent Application Publication
(10) Pub. No.: US 2003/0071744 A1
(43) Pub. Date: Apr. 17, 2003

(54) System for supplying information relating to a public transport network via the internet

(75) Inventors: Zal Shahbaz, Firenze (IT); Gerard Demars, Dardilly (FR)

Correspondence Address: SUGHRUE MION, PLLC, 2100 Pennsylvania Avenue, NW, Washington, DC, 20037-3213, US

(73) Assignee: ALSTOM

(21) Appl. No.: 10/263,672

(22) Filed: Oct. 4, 2002

(30) Foreign Application Priority Data
Oct. 12, 2001 (FR) 01 13 202

(51) Int. Cl. G08G 1/123; G08G 1/095

(52) U.S. Cl. 340/994; 340/907; 340/901; 701/117

(57) ABSTRACT

A system includes an internet server that can be consulted by users of a transport network and a control center for controlling traffic on the network. The control center is connected to sources of data on the status of the traffic and includes automatic data processors for processing data from the sources in order to provide information usable directly by traffic controllers. It further includes connections for transmitting at least some of the directly usable information in real time to the Internet server.

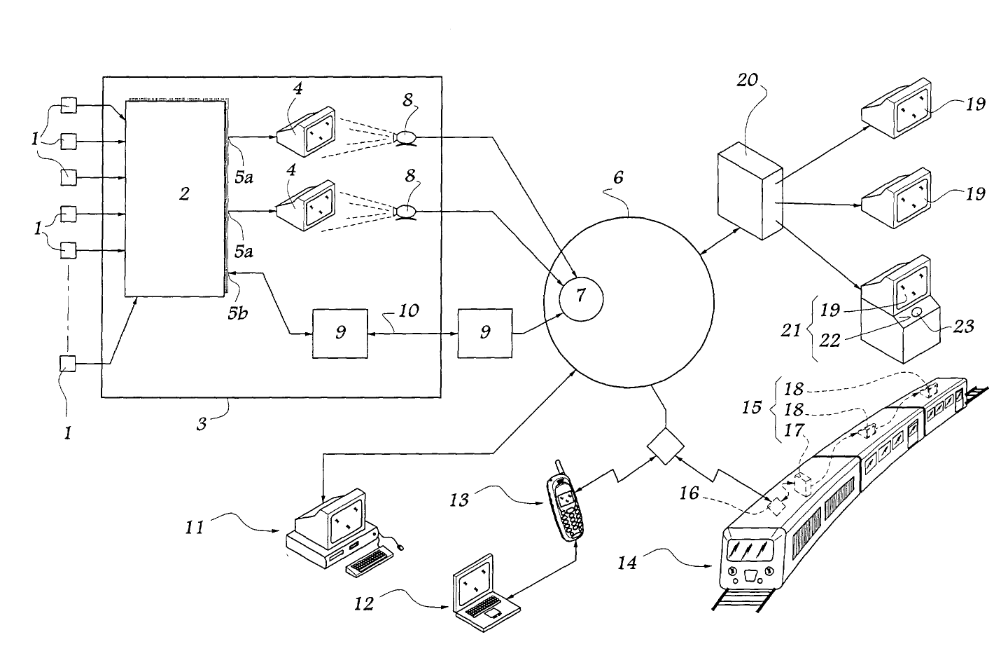

### BACKGROUND OF THE INVENTION

1. Field of the Invention

The present invention relates to a system for supplying via the Internet information relating to a public transport network such as a rail network.

2. Description of the Prior Art

Supplying information to the users of a public transport network by means of an Internet server containing information such as ticket prices or timetables that is regularly updated, for example manually, is known in the art.

On the other hand, information relating to traffic on the transport network at a given time, such as announcements of delays, for example, is supplied only in stations, either visually on display boards or via information telephones, but usually somewhat slowly and somewhat imprecisely. This kind of information is pertinent only if it is renewed substantially in real time, which presupposes that the whole of the process for renewing it is automated.

In most cases, the public transport network has a traffic control center manned by controllers responsible for supervising and regulating the traffic on the transport network. Data from the transport network in particular is collected in the traffic control center and processed to provide information usable directly by the controllers.

An object of the invention is therefore to propose a system adapted to supply via the Internet and at the lowest possible cost information relating to the status of the traffic on a public transport network.

### SUMMARY OF THE INVENTION

To this end, the invention provides a system for supplying via the Internet information relating to a public transport network, the system including:

an Internet server accessible to users of the transport network

a control center for controlling traffic on said transport network, the control center being connected to sources of data on the status of the traffic and including automatic data processor means for processing data from the sources in order to provide information usable directly by traffic controllers, and

connection means for transmitting at least some of the directly usable information in real time to the Internet server.

According to other advantageous features of the above system:

the directly usable information reaches the Internet server in the form of digitized pictures;

the connection means include a first display screen for displaying directly usable information and a video camera viewing the image on the first display screen and adapted to generate the digitized pictures;

the connection means include a connection for routing digital data;

it includes a computer adapted to be connected via the Internet to the Internet server and a second display screen connected to the computer, adapted to display some of the directly usable information and placed in a station of the public transport network so that it can be viewed by users of the transport network;

it includes, on board a vehicle or a train of the public transport network, another computer adapted to be connected via the Internet to the Internet server, means for connecting the other computer to the Internet server via a radio link, and a third display screen connected to the other computer, adapted to display some of the directly usable information, and placed so that it can be viewed by users in the vehicle or on the train;

it includes dialog means associated with the second display screen and/or the third display screen so that a user can dialog with the computer or the computer connected to the screen consulted by the user; and

the public transport network is a rail network.

The invention will be clearly understood after reading the following description, which is given by way of example only and with reference to the single FIGURE of the accompanying drawing.

### BRIEF DESCRIPTION OF THE DRAWINGS

The latter FIGURE is a diagram of a system according to the invention adapted to supply via the Internet information relating to the status of the traffic on a rail transport network (not shown).

### DETAILED DESCRIPTION OF THE PREFERRED EMBODIMENT

In the above system, multiple data sources 1 are connected to automatic data processor means 2. The data mostly relates to the status of the traffic on the rail transport network. For example, it can indicate a delay, an accident or a breakdown.

The automatic processor means 2 are known in the art, like the sources 1, and form part of the equipment of a control center 3 for controlling the traffic on the rail transport network. They collect data from the sources 1 and process it automatically to supply information usable directly by controllers responsible for supervising and regulating the traffic on the rail transport network. The controllers are given the above information by means of display screens 4, each connected to one of a plurality of outputs 5a of the automatic processor means 2.

Some of the directly usable information generated by the automatic processor means 2 takes the form of picture files containing digitized pictures available to the controllers.

The diagram shows the Internet 6, to which is connected an Internet server 7 accessible to users of the rail transport network, for example. Electronic video cameras 8, each viewing all or part of a display screen 4, are connected to the Internet server 7 and can therefore feed it in real time with information initially intended for the controllers.

A display screen 4 and a video camera 8 therefore form connection means, which can all be similar. However, in the example shown, other connection means connect the automatic processor means 2 to the Internet server 7, namely two network interfaces 9 interconnected by a double connection 10 for routing digital data in both directions. One of the network interfaces 9 is connected to the Internet server 7 and the other is connected to an input/output 5b adapted to receive requests from the server 7 and to deliver directly usable information in the form of digitized pictures. Like the connection means in the form of a display screen 4 and a video camera 8, the double connection 10 and the network interfaces 9 transmit to the Internet server 7, directly and in real time, information initially intended for the controllers and contained in signals each of which generates an image.

The server 7 advantageously composes and makes available for consultation new digitized pictures derived from the digitized pictures coming from the automatic processor means 2 and the electronic video cameras 8. For example, it selects, cuts and pastes into a predefined composition portions of the digitized pictures coming from the automatic processor means 2 and the electronic video cameras 8.

Of course, the Internet server 7 can equally contain information such as timetables, connections and/or ticket prices, which has a more general and less individualized character than the information initially intended for the controllers and is updated regularly.

A user can access all this information by means of a computer 11, for example a PC, connected to the Internet 6, or he can use a portable computer 12 connected to the Internet 6 via a cellular telephone 13.

Although in the example shown the portable computer 12 and the cellular telephone 13 are two separate but interconnected devices, it goes without saying that one can be integrated into the other, to form one and the same physical object.

If the user concerned is traveling, he can use the portable computer 12 and the cellular telephone 13 to consult the Internet server 7 and thereby obtain real time information, for example on the status of the train on which he is traveling, on the status of the line on which his train is traveling and/or on the situation with regard to any connections.

To provide all users traveling on board a train 14 with access to the above information, or other, similar information, even if they do not have a portable computer 12 and a cellular telephone 13, the train 14 has an internal network 15 and means 16 for connecting the internal network 15 to the Internet 6, for example by means of a radio link using mobile telephone technology. The internal network 15 includes a host computer 17 which communicates with the Internet server 7 and to which are connected display screens 18 located in the passenger cars so that passengers can consult them.

Users in stations also have real time access to at least some of the information available on the Internet server 7. To this end display screens 19 are installed at various places in the station, for example in the station concourse and on the platforms. The screens 19 are controlled by a host computer 20 which is connected to the Internet 6.

In the example shown, an interactive terminal 21 is formed by associating one of the screens 19 with dialog means 22 provided with a freely rotatable ball 23 and sensors associated with the ball 23, so that a user can dialog with the computer 20 by rotating the ball 23. As an alternative to this, the screen 19 can be a touchsensitive screen.

It goes without saying that dialog means 22 can equally be associated with at least one of the onboard screens 18.

In accordance with the object that the invention seeks to achieve, the system that has just been described is relatively inexpensive, because of its simplicity, especially in comparison with the alternative solution of developing software for making a selection from the information generated by the automatic processor means 2 and presenting that selection in a form that is easy and comfortable to consult.

Furthermore, and again by virtue of its simplicity, the system can be installed quickly, which is advantageous.

It exploits the fact that the automatic processor means 2 supply directly usable information by transmitting a portion of that information directly. Because transmission is direct, it is in real time, which constitutes an additional advantage. Using the Internet 6 enables the information to be made available easily to a large number of users.

There is claimed:

1. A system for supplying via the Internet information relating to a public transport network, said system including:
an Internet server accessible to users of said transport network,
a control center for controlling traffic on said transport network, said control center being connected to sources of data on the status of said traffic and including automatic data processor means for processing data from said sources in order to provide information usable directly by traffic controllers, and
connection means for transmitting at least some of said directly usable information in real time to said Internet server.

2. The system claimed in claim 1, wherein said directly usable information reaches said Internet server in the form of digitized pictures.

3. The system claimed in claim 2, wherein said connection means include a first display screen for displaying directly usable information and a video camera viewing said image on said first display screen and adapted to generate said digitized pictures.

4. The system claimed in claim 1, wherein said connection means include a connection for routing digital data.

5. The system claimed in claim 1, further including a computer adapted to be connected via the Internet to said Internet server and a second display screen connected to said computer, adapted to display some of said directly usable information and placed in a station of said public transport network so that it can be viewed by users of said transport network.

6. The system claimed in claim 1, further including, on board a vehicle or a train of said public transport network, another computer adapted to be connected via the Internet to said Internet server, means for connecting said other computer to said Internet server via a radio link, and a third display screen connected to said other computer, adapted to display some of said directly usable information, and placed so that it can be viewed by users in said vehicle or on said train.

7. The system claimed in claim 5, further including dialog means associated with said second display screen and/or said third display screen so that a user can dialog with the computer connected to the screen consulted by said user.

8. The system claimed in claim 1, wherein said public transport network is a rail network.
